(19) United States
(12) Patent Application Publication
(10) Pub. No.: US 2026/0331923 A1
(43) Pub. Date: Oct. 22, 2026

(54) DRILLING RIG POWER SYSTEM AND ASSOCIATED METHOD

(71) Applicant: Caterpillar Inc., Peoria, IL (US)

(72) Inventor: Brad C DEVORAK, Lafayette, IN (US)

(73) Assignee: Caterpillar Inc., Peoria, IL (US)

(21) Appl. No.: 19/185,788

(22) Filed: Apr. 22, 2025

(51) Int. Cl. H02J 3/38; E21B 19/084

(52) U.S. Cl. CPC H02J 3/38; H02J 2101/10

(57) ABSTRACT

A drilling rig includes: a power system including: at least one genset configured to produce electrical power; a bus electrically connected with the at least one genset; at least one power consumer electrically connected with the bus, where the bus is configured to distribute electrical power produced by the at least one genset to the at least one power consumer; a load bank electrically connected with the bus; and a controller configured to detect, at a first time point, a first frequency of the electrical power at the bus; determine whether the first frequency satisfies a first threshold; control the load bank, based on the first frequency satisfying the first threshold, to reduce a load applied by the load bank to the at least one genset; detect, at a second time point after the first time point, a second frequency of the electrical power at the bus; determine whether the second frequency satisfies a second threshold; and control the load bank, based on the second frequency satisfying the second threshold, to increase a load applied to the at least one genset by the load bank.

### TECHNICAL FIELD

The present disclosure relates generally to power systems and associated methods, and, more particularly, to power systems and associated methods for drilling rigs.

### BACKGROUND

Drilling rigs, whether mobile or stationary, may be used for mining, drilling gas and oil wells, and other applications. Drilling rigs generally include power systems, which supply power to various components on the drilling rigs, including drawworks, mud pumps, air compressors, top drives, and other components. The power requirements of the various components, and thus the total power requirements for the drilling rig, change as the components perform different operation. For example, during tripping operations when drawworks raise or lower pipe sections, the power requirements of the drilling rigs are generally at a maximum. The power systems should be capable of meeting the power requirements of the drilling rigs during this period of peak power demand, but should also be capable of operating to provide power when the various components require minimum power, for example.

The power systems usually include one or more generator sets (also referred to as gensets), which are combinations of engines that produce mechanical power, with generators that convert the mechanical power into electrical power. Some power systems may ramp up and ramp down the gensets, so that the gensets themselves produce more or less electrical power, as the power requirements of the drilling rigs change. However, frequently ramping up and down the gensets can be inefficient and reduce the life of the gensets. Further, some gensets, including natural gas gensets, may be incapable of being operated at both the required minimum and maximum power levels.

US 2011/0074165 to Grimes et al. (“US '165”) discloses a system for controlling power load to a rig engine of a wellbore rig. US '165 uses a power logic controller to charge a battery bank or flywheels, for example with energy output from an engine, and then uses the energy stored in the battery bank or flywheels when required. However, such energy storage systems are expensive, heavy, and take up large volumes. Further, these energy storage systems may not work effectively in hot or cold environments.

Accordingly, systems and methods according to the present disclosure may address or solve one or more problems in the art. The scope of the current disclosure, however, is defined by the attached claims, and not by the ability to solve any specific problem.

### SUMMARY

In some aspects, the disclosure provides a drilling rig comprising: a power system comprising: at least one genset configured to produce electrical power; a bus electrically connected with the at least one genset; at least one power consumer electrically connected with the bus, where the bus is configured to distribute electrical power produced by the at least one genset to the at least one power consumer; a load bank electrically connected with the bus; and a controller configured to: detect, at a first time point, a first frequency of the electrical power at the bus; determine whether the first frequency satisfies a first threshold; control the load bank, based on the first frequency satisfying the first threshold, to reduce a load applied by the load bank to the at least one genset; detect, at a second time point after the first time point, a second frequency of the electrical power at the bus; determine whether the second frequency satisfies a second threshold; and control the load bank, based on the second frequency satisfying the second threshold, to increase a load applied to the at least one genset by the load bank.

In some aspects, the disclosure provides a power system for a drilling rig, comprising: at least one genset configured to produce electrical power; a bus electrically connected with the at least one genset; at least one power consumer electrically connected with the bus, wherein the bus is configured to distribute electrical power produced by the at least one genset to the at least one power consumer; a load bank electrically connected with the bus, wherein the bus is configured to supply electrical power produced by the at least one genset to the load bank; and a controller configured to control the load bank to apply a load to the at least one genset based on a frequency of the electrical power.

In some aspects, the disclosure provides a method of powering a drilling rig, the method comprising: producing electrical power with at least one genset; distributing the electrical power produced by the at least one genset, through a bus, to at least one power consumer; commanding, with a controller, a load bank to apply a load to the at least one genset; determining a frequency of the electrical power at the bus is less than a first predetermined threshold, the first predetermined threshold indicating that the at least one power consumer is performing an operation; and commanding, with the controller, the load bank to reduce application of the load to the at least one genset during the operation.

### BRIEF DESCRIPTION OF THE DRAWINGS

The accompanying drawings, which are incorporated in and constitute a part of this Specification, illustrate various aspects of the disclosure, and, together with the description, serve to explain aspects of the disclosure.

FIG. 1 illustrates an exemplary machine, in the form of a drilling rig, and including a power system, in accordance with some embodiments of the disclosure.

FIG. 2 illustrates an exemplary block diagram of the power system of FIG. 1, in accordance with some aspects of the disclosure.

FIG. 3 is a graph showing an exemplary drilling cycle in which the power system of FIGS. 1 and 2 may be used, in accordance with some aspects of the disclosure.

FIG. 4 is an exemplary method, in accordance with some aspects of the disclosure.

### DETAILED DESCRIPTION

Both the foregoing general description and the following detailed description are exemplary and explanatory only, and do not restrict the claims. The terms “comprises,” “comprising,” “having,” “including,” or other variations thereof, used herein cover a non-exclusive inclusion such that a process, method, article, or apparatus that comprises a list of elements does not necessarily include only those elements, but may include other elements not expressly listed or inherent to such a process, method, article, or apparatus. Further, relative terms, such as, for example, “about,” “substantially,” “generally,” “approximately,” or other variations thereof, may include both a stated value and a possible variation of ±10% in the stated value, unless described otherwise. Still further, the terms “one or more,” “at least one,” and variations thereof, include one, two, or more than two (e.g., a plurality). Additionally, terms such as “top” and “bottom” are exemplary only and may refer to an orientation of a component in a particular figure or in installation or use, for example, but do not require that the component is oriented such that a “top” is above a “bottom.”

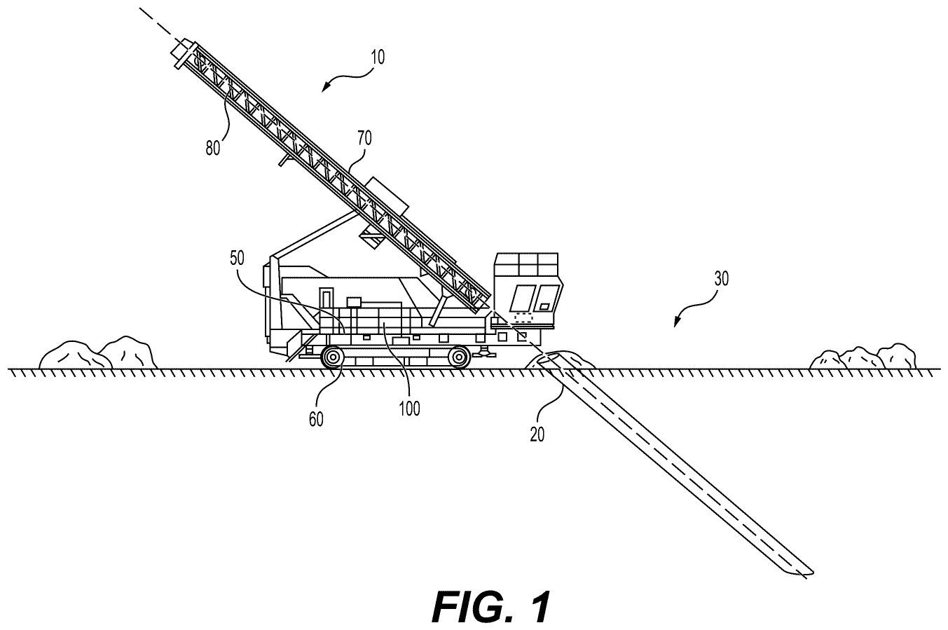

With reference to the drawings, FIG. 1 illustrates an exemplary machine 10, in the form of a drilling rig, including a power system 100 for supplying power to the machine 10, in accordance with some embodiments of the disclosure. As discussed in more detail below, FIG. 1 shows a borehole 20 drilled in a drill site 30, and the machine 10 including a chassis or frame 50, propulsion devices 60, a mast 70, a drawworks 80, and the power system 100, among other machine features.

Although FIG. 1 illustrates the machine 10 as a mobile drilling rig capable of propelling itself across a ground surface, the machine 10 may be in the form of another machine or drilling rig, such as a stationery drilling rig that is towed across the ground surface by another machine or assembled at a location, or an offshore drilling rig, among other machines. Returning to FIG. 1, the machine 10 in the form of a drilling rig may be used to drill the borehole 20 into the ground surface and underlying subsurface at the drill site 30, and subsequently insert a drill string in the borehole 20 (e.g., during a tripping operation), for oil and gas extraction (e.g., for drilling oil and gas wells).

As FIG. 1 shows and as stated above, the machine 10 may include the frame 50. In some embodiments, when the machine 10 is a mobile drilling rig, the machine 10 may include the propulsion devices 60 connected to the frame 50, the propulsion devices 60 including one or more wheels or continuous tracks for moving the machine 10 across the ground surface of the drill site 30. In some embodiments, the machine 10 may omit the propulsion devices 60. As also stated above, the machine 10 may include the mast 70, which may be pivotally coupled to the frame 50 so that the mast 70 may be positioned at various angles relative to the ground surface. The mast 70 may include the drawworks 80 for raising and lowering pipe sections into the borehole 20. Although not shown, the machine 10 may include other power consumers in addition to the drawworks 80, such as one or more mud pumps or top drives.

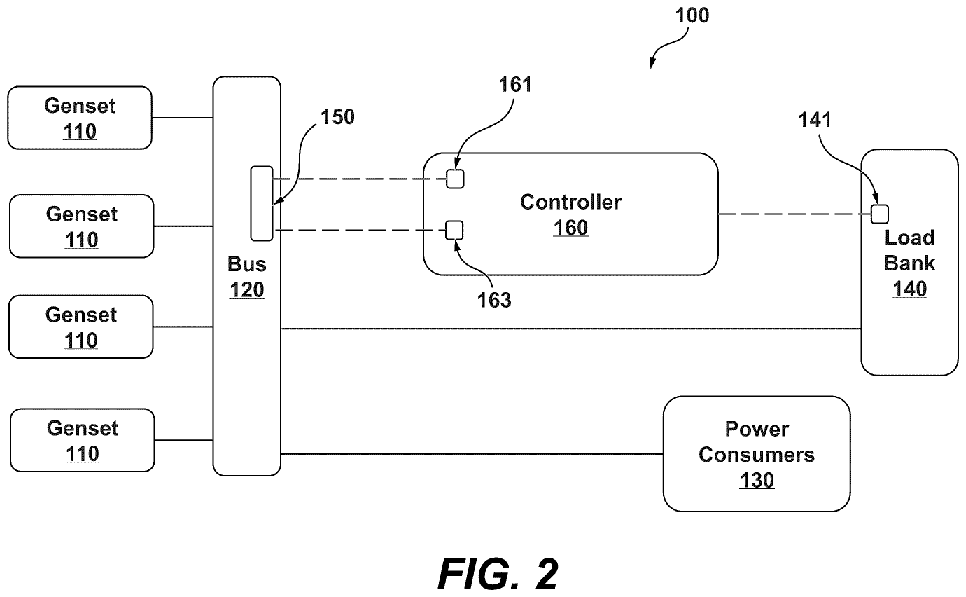

FIG. 2 illustrates an exemplary block diagram of the power system 100 of the machine 10, in accordance with some aspects of the disclosure. The power system 100 may include one or more generator sets (gensets) 110 as electrical power producers, a bus 120, one or more power consumers 130, a load bank 140, a control module 141, a sensor 150, a controller 160, a power frequency information module 161, and a genset counter module 163, among other components, as further described. In FIG. 2, solid lines illustrate electrical connections, while dashed lines indicate communication. Although FIG. 2 illustrates that the exemplary power system 100 may include four gensets 110, the power system 100 may include any number of gensets 110, such as fewer or more than four gensets 110. Generally, the power system 100 may include a sufficient number of gensets 110, such that the power system 100 may provide power sufficient to operate all the power consumers 130 of a drilling rig under all operating conditions. As described, in accordance with some aspects of the disclosure, the machine 10 may be a drilling rig used to drill oil or gas wells, and the power consumers 130 may include one or more of a top drive, a mud pump, a rotary table, air compressors, the drawworks 80, or other power consumers. In accordance with some aspects of the disclosure, one or more of the gensets 110 may be a natural gas genset that includes an engine producing mechanical power by combustion of natural gas, and a generator producing electrical power through a conversion of the mechanical power produced by the engine. In some examples, the natural gas gensets may be fueled by the natural gas provided by the well that is drilled by the drilling rig. The phrase “natural gas” genset refers to gensets that are capable of one or both of: operation using solely natural gas or a similar gaseous fuel (as used herein, a gaseous fuel is a fuel that is configured to be delivered to an admission valve or fuel injector while in a gaseous state), or operation using natural gas and a pilot fuel (e.g., diesel fuel). In some aspects of the disclosure, the electrical power produced by the gensets 110 is 3-phase power with a frequency of about 60 Hz.

Although the foregoing description describes the power system 100 as including the gensets 110 as the power producers, it is understood that the power system 100 may include other engines, turbines, motors, generators, or generator sets, in addition to or in place of the gensets 110. Further, in some aspects of the disclosure, the electrical power produced by the power producers, whether the power producers do or do not include the gensets 110 or natural gas gensets, may be something other than 3-phase power with a frequency of about 60 Hz.

The power system 100 may include the bus 120, which may receive and subsequently distribute the power generated by the gensets 110. As FIG. 2 shows, the bus 120 may distribute the power generated by and received from the gensets 110 to the power consumers 130 and the load bank 140, as further described. For example, the power consumers 130 may apply an electrical load to the bus 120 based on the electrical power requirements of the power consumers 130. The load bank 140 may be controlled by the controller 160 to apply an electrical load to the bus 120, such that under some conditions at least a portion of the power produced by the gensets 110 is distributed by the bus 120 to the load bank 140, thereby reducing the amount of power distributed to the power consumers 130. In accordance with some aspects of the disclosure, the load bank 140 may be in the form of a resistor load bank, which includes one or more resistors.

The bus 120 may also receive and subsequently pass along information from the gensets 110, including the number of gensets 110 that are connected to the bus 120, a maximum power output of each of the gensets 110, and a frequency of the electrical power at the bus 120. In accordance with some aspects of the disclosure, a sensor 150 may be installed on or otherwise may be in electrical communication with the bus 120, the sensor 150 configured to detect or sense the frequency of the electrical power at the bus 120.

The controller 160 may receive the information from the bus 120, and may subsequently control operation of the load bank 140, thereby increasing or decreasing the electrical load that the load bank 140 applies to the bus 120, and accordingly decreasing or increasing the amount of electrical power distributed by the bus 120 to the power consumers 130. As FIG. 2 illustrates, the controller 160 may include a power frequency information module 161 and a genset counter module 163. The power frequency information module 161 may receive, such as from the sensor 150, information regarding the frequency of the power at the bus 120. The genset counter module 163 may receive information regarding the number of gensets 110 that are connected to the bus 120, such as by a sensor 150 or another sensor, such that the controller 160 may determine a maximum amount of power that may be generated by all of the gensets 110 together.

As further described below, the controller 160 may control the amount of power that is distributed to the load bank 140 (e.g., the controller 160 may control the load that the load bank 140 applies to the bus 120) based on the frequency of the electrical power at the bus 120, as measured by the sensor 150, because the frequency of the electrical power at the bus 120 may vary based on the load applied by the power consumers 130. For example, in accordance with some aspects of the disclosure, when the frequency of the electrical power at the bus 120 is below a first predetermined threshold value, the controller 160 may determine that the power consumers 130 require more power, and thus the controller 160 may control operation of the load bank 140 to decrease the load that the load bank 140 applies to the bus 120, thereby decreasing the amount of power distributed to the load bank 140. This may correspond to the commencement of the tripping operation, for example. As FIG. 2 illustrates, the load bank 140 may include a control module 141 that receives a command from the controller 160, which operates the load bank 140 to increase or decrease the load that the load bank 140 applies to the bus 120.

When the frequency of the electrical power is above a second predetermined threshold value, the controller 160 may determine that the power consumers 130 no longer require maximum power but instead require less power, and thus the controller 160 may control operation of the load bank 140 to increase the load applied to the bus 120, thereby increasing the amount of power distributed to the load bank 140, and decreasing the amount of power distributed to the power consumers 130. This may correspond to the conclusion of the tripping operation.

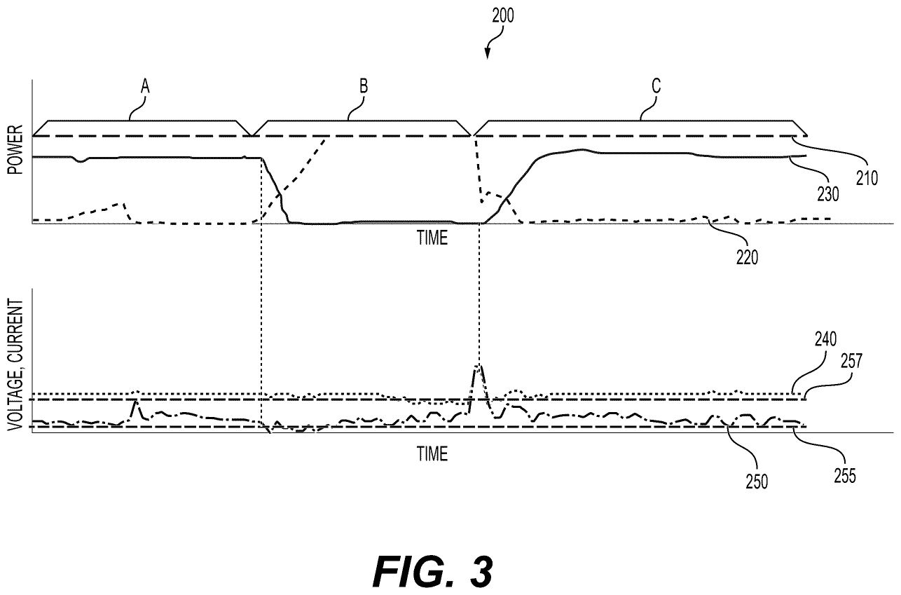

In accordance with some aspects of the disclosure, any of the disclosed controllers or control modules may embody a single microprocessor or multiple microprocessors. For example, any of the controller 160, the control module 141, the power frequency information module 161, or the genset counter module 163 may include a memory, a secondary storage device in addition to or other than the memory, a processor, such as a central processing unit, or any other system or systems for accomplishing a task consistent with the present disclosure. The memory or secondary storage device associated with the controller or modules may include non-transitory computer-readable media that store data or one or more software routines that may assist the controller or modules in performing its functions, such as the functions of method or process discussed above with reference to FIGS. 2 and 3 discussed below. Further, the memory or secondary storage device associated with the controller or modules may also store data received from the various inputs or sensors, including from the sensor 150, which are associated with the machine 10, including the inputs discussed throughout the disclosure. Numerous commercially available microprocessors may be programmed or otherwise configured to perform one or more of the functions of the controller or modules. In some instances, the controller or modules may include a general machine controller capable of controlling numerous other functions of the machine 10, whether or not the machine 10 is in the form of a drilling rig. Various other known circuits may be associated with the controller or modules, including signal-conditioning circuitry, communication circuitry, hydraulic or other actuation circuitry, or other appropriate circuitry.

### Industrial Applicability

The disclosure may provide systems and methods associated with the power system 100 of the machine 10, including drilling rigs. In at least some embodiments, the disclosed power system 100 may be used on drilling rigs for mining applications (e.g., blasthole mining), oil and gas applications, and others. The power system 100 may be used on mobile drilling rigs, or stationary drilling rigs, that are powered with electricity generated via one or multiple gensets 110.

For example, the power system 100 may include the gensets 110, such as in the form of gaseous fuel (e.g., natural gas) gensets, which may operate at steady state, such that the gensets 110 are neither ramped up nor ramped down depending on the power requirements of the power consumers 130, such as a top drive, a mud pump, a rotary table, an air compressor, and the drawworks 80, during different phases or time periods, starting and beginning at different time points, during a drilling cycle. Thus, the gensets 110 may not be required to be ramped up when the drawworks 80 performs a tripping operation and the power requirements of the power consumers 130 are at a maximum. Further, the gensets 110 may not be required to be ramped down when the power requirements of the power consumers 130 are at a minimum. Rather, in accordance with the disclosure, when the gensets 110 produce excess electrical power that is not required by the power consumers 130, the controller 160 may control the load bank 140 to apply a load to the gensets 110. When the maximum power that the gensets 110 produce is required by the power consumers 130, such as during the tripping operation, the controller 160 may control the load bank 140 to reduce the applied load, or apply no load, to the gensets 110. As disclosed, the controller 160 may control the load bank 140 based on the frequency of the electrical power at the bus 120, as measured by the sensor 150 installed on or otherwise in electrical communication with the bus 120.

FIG. 3 is a graph 200 showing an exemplary drilling cycle illustrating electrical power as a function of time, in accordance with some aspects of the disclosure. On the graph 200, line 210 may represent a generator power, which in accordance with some aspects of the disclosure may indicate the total electrical power produced by all of the gensets 110 (or other power producers) of the power system 100, for example, as a function of time. As FIG. 3 shows, the line 210 may be a generally straight line with a value above zero and a slope of about zero, indicating that the total electrical power produced by the gensets 110 generally may be constant or substantially constant. For example, all of the gensets 110 may operate to provide a constant maximum amount of electrical power, such that none of the gensets 110 are ramped up or ramped down during any time interval of the drilling cycle. Although, during steady state operation, the generator power represented by line 210 is intended to remain relatively stable around an average value, the generator power may experience fluctuations and other changes during operation, and the present disclosure is not limited to constant or substantially constant power output from the gensets 110.

On the graph 200, curve 220 may represent a drill rig load, which in accordance with some aspects of the disclosure may represent the electrical power demand of the power consumers 130 of the power system 100, for example. As discussed, the power consumers 130 may be connected to the gensets 110 by the bus 120.

As FIG. 3 shows, during a time interval A, which may indicate a time interval prior to commencement of a tripping operation, the value of the curve 220 may vary depending on the requirements of the power consumers 130, but may be lower than the value of the line 210. For example, as FIG. 3 illustrates, during the time interval A, by comparing the values of line 210 and curve 220, the graph indicates that the amount of power demand by the power consumers 130 before commencement of the tripping operation may be less than 50% (e.g., less than 25% or less than 10%) of the electrical power produced by the gensets 110. As discussed, the power consumers 130 may include components such as a drawworks, a mud pump, a rotary table, an air compressor, and the drawworks 80, which may operate to perform various operations of the drill rig.

As FIG. 3 further shows, during a time interval B, which may indicate a time interval beginning with commencement of the tripping operation and ending when the tripping operation ceases, and thus representing a period of peak power demand by the machine 10, the amount of electrical power provided to the power consumers 130 may increase to an amount that is about equal to the amount of power produced by the gensets 110. For example, as time passes, the values of the curve 220 may approach and eventually be substantially equal to the values of the line 210. Accordingly, the graph 200 shows that the power demand of the power consumers 130 during the tripping operation matches the maximum power capacity of the gensets 110.

As FIG. 3 still further illustrates, during a time interval C, which may indicate a time interval after which the tripping operation has ended, as time passes, the amount of electric power demand of the power consumers 130 may decrease, until the values of the curve 220 during time interval C are similar to the values of the curve 220 during the time interval A.

On the graph 200, curve 230 may represent a load bank load, which in accordance with some aspects of the disclosure may include an electrical load applied by the load bank 140 of the power system 100. As FIG. 3 shows, during the time interval A, which may indicate the time interval prior to the tripping operation, values of the curve 230 may vary depending on the power demand of the power consumers 130. For example, depending on the demand of the power consumers 130, the controller 160 may command the load bank 140 to apply an electrical load to the power system 100, such that a total of the power provided to the power consumers 130 and the load applied by the load bank 140 are approximately equal to the total electrical power produced by the gensets 110. As FIG. 3 shows, during the time interval A, because the amount of power demand of the power consumers 130 may be less than 50% (e.g., less than 25% or less than 10%) of the electrical power produced by the gensets 110, the load applied by the load bank 140 may be greater than about 50% (e.g., greater than 75% or greater than 90%) of the electrical power produced by the gensets 110.

As FIG. 3 further shows, during the time interval B, which may represent the time interval during which the tripping operation occurs and thus the period of peak power demand, because the amount of electrical power required by the power consumers 130 may increase to a value equal to, or about equal to, the maximum amount of the electrical power produced by the gensets 110, the value of the load applied by the load bank 140 may decrease to zero, or about zero. Thus, for example, during the time interval B, as time passes, the values of curve 230 may decrease to zero, or about zero.

As FIG. 3 further illustrates, during the time interval C, which may represent the time interval after which the tripping operation occurs, because the amount of electric power required by the power consumers 130 may decrease, the load applied by the load bank 140 may increase, until the values of the curve 230 during time interval C are similar to the values of the curve 230 during the time interval A.

On the graph 200 of FIG. 3, curve 240 may represent a voltage of the power at the bus 120, and curve 250 may represent a frequency of the power at the bus 120, as measured by the sensor 150 for example. As FIG. 3 illustrates, when the tripping operation begins (e.g., at the end of the time interval A and at the beginning of time interval B), the frequency of the power at the bus 120 may decrease to a greater extent and more quickly than the voltage of the power at the bus 120. Thus, in accordance with some aspects of the disclosure, when the measured frequency of the power at the bus 120 is below a first threshold value 255, the controller 160 may control the load bank 140 to apply substantially no load to the bus 120.

As FIG. 3 further illustrates, when the tripping operation concludes or ends (e.g., at the end of the time interval B and at the beginning of time interval C), the frequency of the power at the bus 120 may increase to a greater extent and more quickly than the voltage of the power at the bus 120. Thus, in accordance with some aspects of the disclosure, when the measured frequency of the power at the bus 120 is above a second threshold value 257, the controller 160 may control the load bank 140 to begin to apply a load to the bus 120, such as based on the power demand of the power consumers 130 (curve 220) and the total power produced by the gensets 110 (line 210). For example, the controller 160 may control the load bank 140 to apply a load to the bus 120 that is equal to a difference between the total power provided by the gensets 110 and the amount of power used by the power consumers 130.

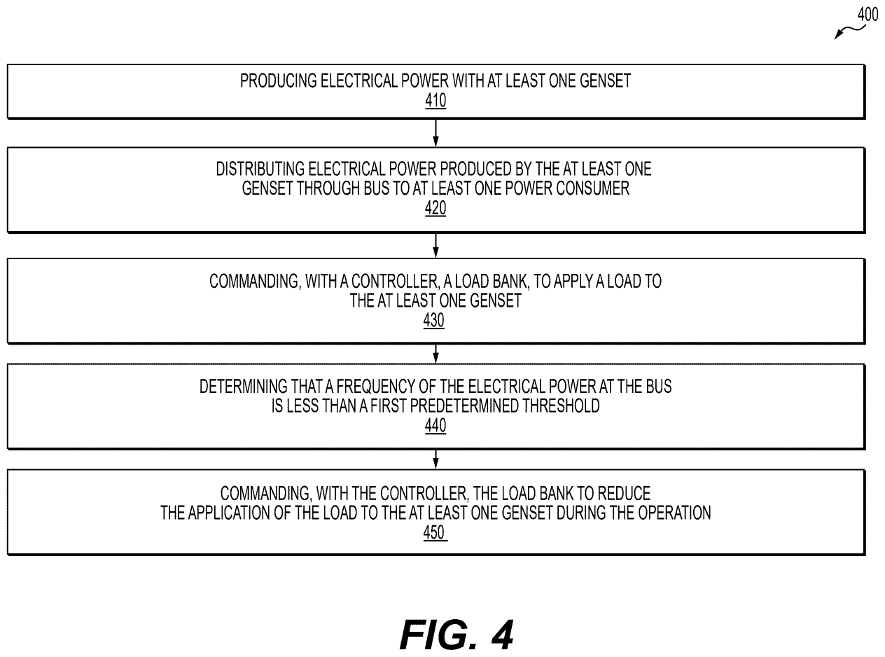

FIG. 4 is a flowchart illustrating steps of an exemplary method 400, in accordance with some aspects of the disclosure. The method 400 may include a step 410 of producing electrical power with the at least one genset, or other power producer, such as the genset 110. The method 400 may include a step 420 of distributing the electrical power produced by the at least one genset, through a bus, such as the bus 120, to the at least one power consumer, such as the power consumer 130. The method 400 may include a step 430 commanding, with a controller, such as the controller 160, a load bank, such as the load bank 140, to apply a load to the at least one genset. The method 400 may include a step 440 of determining that a frequency of the electrical power at the bus is less than a first predetermined threshold, the first predetermined threshold indicating that the at least one power consumer is performing an operation, such as a tripping operation. The method 400 may include a step 450 of commanding, with the controller, the load bank to cease application of the load to the at least one genset during the operation. Although the foregoing method 400 includes certain steps, methods in accordance with the disclosure may include more steps, less steps, additional steps, or one or more steps in another order.

In accordance with the above disclosure, the disclosed systems and methods provide numerous advantages. By way of some examples, the gensets 110 may operate at steady state—e.g., the gensets 110 may be neither ramped up or ramped down, such as depending on the power requirements of the power consumers 130. Thus, wear and tear on the gensets 110 may be reduced, and the lifetime of the gensets 110 may be increased. Further, the power system 100 may use gensets 110, such as natural gas gensets, that are incapable of otherwise operating in the power system 100, because natural gas gensets cannot respond to the transient loads required by the power system 100. Further, the power system 100 may omit any energy storage system, thereby decreasing the cost, weight, and volume of the power system 100.

It will be apparent to those skilled in the art that various modifications and variations may be made to the disclosed system without departing from the scope of the disclosure. Other aspects of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A drilling rig, comprising:
a power system comprising:
at least one genset configured to produce electrical power;
a bus electrically connected with the at least one genset;
at least one power consumer electrically connected with the bus, wherein the bus is configured to distribute electrical power produced by the at least one genset to the at least one power consumer;
a load bank electrically connected with the bus; and
a controller configured to:
detect, at a first time point, a first frequency of the electrical power at the bus;
determine whether the first frequency satisfies a first threshold;
control the load bank, based on the first frequency satisfying the first threshold, to reduce a load applied by the load bank to the at least one genset;
detect, at a second time point after the first time point, a second frequency of the electrical power at the bus;
determine whether the second frequency satisfies a second threshold; and
control the load bank, based on the second frequency satisfying the second threshold, to increase a load applied to the at least one genset by the load bank.

2. The drilling rig of claim 1, wherein the at least one genset comprises a plurality of gensets.

3. The drilling rig of claim 1, wherein the at least one genset comprises a plurality of natural gas gensets.

4. The drilling rig of claim 1, wherein the at least one power consumer comprises a plurality of power consumers that includes a drawworks.

5. The drilling rig of claim 1, wherein the load bank comprises a plurality of resistors.

6. The drilling rig of claim 1, wherein the at least one power consumer comprises a drawworks, and
wherein the controller is configured to control the load bank to apply no load to the at least one genset when the drawworks performs a tripping operation.

7. The drilling rig of claim 1, wherein the at least one power consumer comprises a drawworks,
wherein the controller is configured to control the load bank to apply no load to the at least one genset when the drawworks performs a tripping operation, and
wherein the controller is configured to determine a commencement of the tripping operation when the first frequency of the electrical power at the bus is less than the first threshold.

8. The drilling rig of claim 1, further comprising a sensor configured to sense the frequency of the electrical power at the bus,
wherein the at least one power consumer comprises a drawworks,
wherein the controller is configured to control the load bank to apply no load to the at least one genset when the drawworks performs a tripping operation,
wherein the controller is configured to determine a commencement of the tripping operation when the first frequency of the electrical power at the bus, as measured by the sensor, is less than the first threshold,
wherein the controller is configured to control the load bank to apply a load to the at least one genset when the drawworks is not performing the tripping operation, and
wherein the controller is configured to determine a conclusion of the tripping operation when the second frequency of the electrical power at the bus, as measured by the sensor, is greater than the second threshold, wherein the second threshold is greater than the first threshold.

9. A power system for a drilling rig, comprising:
at least one genset configured to produce electrical power;
a bus electrically connected with the at least one genset;
at least one power consumer electrically connected with the bus, wherein the bus is configured to distribute electrical power produced by the at least one genset to the at least one power consumer;
a load bank electrically connected with the bus, wherein the bus is configured to supply electrical power produced by the at least one genset to the load bank; and
a controller configured to control the load bank to apply a load to the at least one genset based on a frequency of the electrical power.

10. The power system of claim 9, wherein the at least one genset comprises a plurality of gensets.

11. The power system of claim 9, wherein the at least one genset comprises a plurality of gensets configured for use with gaseous fuel.

12. The power system of claim 9, wherein the at least one power consumer comprises a plurality of power consumers that includes a drawworks.

13. The power system of claim 9, wherein the load bank comprises a plurality of resistors.

14. The power system of claim 9, wherein the at least one power consumer comprises a drawworks,
wherein the controller is configured to control the load bank to reduce a load applied by the load bank when the drawworks performs a tripping operation.

15. The power system of claim 9, wherein the at least one power consumer comprises a drawworks,
wherein the controller is configured to control the load bank to reduce a load applied by the load bank when the drawworks performs a tripping operation, and
wherein the controller is configured to determine a commencement of the tripping operation when the frequency of the electrical power at the bus is less than a predetermined threshold.

16. The power system of claim 9, further comprising a sensor configured to sense the frequency of the electrical power at the bus,
wherein the at least one power consumer comprises a drawworks,
wherein the controller is configured to control the load bank to apply no load to the at least one genset when the drawworks performs a tripping operation,
wherein the controller is configured to determine a commencement of the tripping operation when the frequency of the electrical power at the bus, as measured by the sensor, is less than a first predetermined threshold,
wherein the controller is configured to control the load bank to apply a load to the at least one genset when the drawworks concludes a tripping operation, and
wherein the controller is configured to determine a conclusion of the tripping operation when the frequency of the electrical power at the bus, as measured by the sensor, is greater than a second predetermined threshold, wherein the second predetermined threshold is greater than the first predetermined threshold.

17. A method of powering a drilling rig, the method comprising:
producing electrical power with at least one genset;
distributing the electrical power produced by the at least one genset, through a bus, to at least one power consumer;
commanding, with a controller, a load bank to apply a load to the at least one genset;
determining a frequency of the electrical power at the bus is less than a first predetermined threshold, the first predetermined threshold indicating that the at least one power consumer is performing an operation; and
commanding, with the controller, the load bank to reduce application of the load to the at least one genset during the operation.

18. The method of claim 17, wherein the at least one genset comprises a plurality of gensets configured for combustion of gaseous fuel.

19. The method of claim 17, further comprising:
determining a frequency of the electrical power at the bus is greater than a second predetermined threshold, the second predetermined threshold indicating that the at least one power consumer has ceased performing the operation, wherein the second predetermined threshold is greater than the first predetermined threshold; and
commanding, with the controller, the load bank to begin application of a load to the at least one genset after ceasing the operation.

20. The method of claim 17, wherein the at least one genset comprises a plurality of natural gas gensets,
wherein the at least one power consumer comprises a drawworks, a mud pump, a rotary table, an air compressor, or a drawworks,
wherein the operation comprises a tripping operation.
